(19) United States
(12) Patent Application Publication
(10) Pub. No.: US 2002/0133434 A1
(43) Pub. Date: Sep. 19, 2002

(54) System and method for controlling the delivery of items from a seller to a buyer

(76) Inventors: Keith Gerald Nevel, Erie, PA (US); Douglas James Thompson, Erie, PA (US)

Correspondence Address: David G. Maire, Esquire, Beusse, Brownlee, Bowdoin & Wolter, P.A., Suite 2500, 390 North Orange Avenue, Orlando, FL, 32801, US

(21) Appl. No.: 09/811,763

(22) Filed: Mar. 19, 2001

(51) Int. Cl. G06F 17/60

(52) U.S. Cl. 705/28

(57) ABSTRACT

A system (10) and method (44) for allowing a buyer (18) to control the shipment of items from a plurality of sellers (12, 14, 16). The sellers gain access to a buyer-controlled procurement database (38) via a global information network (20) in order to obtain shipping instructions for a quantity of items that are identified for shipment (I). A buyer data processor (34) communicates shipping instructions to the seller for local printing in a format controlled by the buyer. The printing instructions may take the form of a buyer-defined shipping label utilizing a predetermined bar code format. The buyer data processor will approve a quantity for shipment (A) only if the number of items ordered (O) less the number of items previously received (R) or the number of shipping labels previously prepared (P) is greater than or equal to the number of items identified as ready for shipment. (A≧I for A=O−P or A=O−R) The seller may specify a quantity of packages to be used for the shipment, and the system will prepare a corresponding number of shipping labels. By accessing an inventory control system (96), the system may be used to direct a particular shipment to a location having the most urgent need for the item being shipped.

### FIELD OF THE INVENTION

This invention relates generally to the field of material control, and more particularly to the field of procurement shipping control.

### BACKGROUND OF THE INVENTION

The control of the delivery of materials between a buyer and a seller can be a complex undertaking when the buyer is a large business dealing with a large number of suppliers. The buyer may issue a large number of purchase orders to a large number of suppliers for a large number of individual parts to be delivered over a long period of time to a number of different locations. The buyer may have an established inventory system that must exchange data with its established procurement system, making it imperative that incoming packages are properly marked in a predetermined format for effective receipt information tracking. Many buyers prefer to have procurement and shipping information encoded in a bar code format in order to simplify the logistics of data entry at the receiving location. However, most small sellers do not have access to bar code encoding systems, and if they do, the seller's system is likely not to be compatible with the bar coding scheme used by the buyer.

One known system for coordinating shipping and receiving information is taught in U.S. Pat. No. 6,015,167, issued to Savino, et al, issued on Jan. 18, 2001. That system allows a buyer to access a seller's Internet web site to check for the availability of a particular part. If the part is available, the buyer may enter procurement information, including shipping instructions, into the seller's database. The seller's digital processor then processes the order for shipment, including the generation of a single bar code to be used on the shipping label. By scanning this bar code while connected to the seller's web site, both the buyer and the seller may access purchasing and shipping information related to the order from the seller's database.

While the system described in the Savino patent may be useful for use by a large seller dealing with a large number of small buyers, it fails to satisfy many of the needs of a large buyer that must deal with a large number of sellers. For example, the prior art system is designed for the shipment of orders of in-stock parts from a seller's inventory. It does not address the situation of parts made to order for delivery on one or more future delivery dates. The bar code and shipping label of the Savino system are controlled by the seller's digital processor, since the seller is the dominant commercial entity in this type of transaction. A large buyer ordering from a plurality of sellers each using the Savino system would be faced with inconsistent bar code formats. Importantly, the buyer has no control over the order once the order is placed, particularly with regard to quantity control. The system of Savino does not anticipate or solve a problem with quantity control, such as where the seller ships a quantity that is greater than the quantity ordered. Because the seller in the system of Savino is a large seller is generating a single shipment of in-stock items in direct response to a plurality of single orders, few problems with quantity control would be expected. However, in an application where a large buyer may place more than one order for the same part from a single seller, and where the delivery of those parts may be staggered over a long period of time and may be made to a plurality of locations, the problem of quantity control can be significant.

### BRIEF SUMMARY OF THE INVENTION

Thus there is a particular need for a system and method of controlling the delivery of items from a seller to a buyer that particularly addresses the needs of a large buyer dealing with a large number of sellers. Such a system and method should provide the buyer with control over the format of shipping information placed on delivered packages, and control over the quantity of items to be shipped by the sellers. Such a system and method should further provide the buyer with flexibility in directing shipments to be responsive to just-in-time delivery requirements. Furthermore, such a system and method must be useable by a plurality of sellers without the need for specialized equipment or software.

Accordingly, a computer implemented method of controlling the shipment of goods from a seller to a buyer is disclosed herein, as including: accessing a buyer data processor including a procurement database from a seller interface device via a communications network; selecting information associated with a procurement order from the procurement database; identifying via the seller interface device a quantity of items associated with the selected procurement order that are identified for shipment; and providing shipping instructions from the buyer data processor for the quantity of items. The shipping instructions are preferably provided in the form of printing instructions for enabling the seller interface device to print a shipping label in a predetermined format, including a bar code, to be used for delivery of the items to the buyer.

The method may further include: maintaining in the procurement database a quantity of items approved for shipment equal to a quantity of items ordered minus a quantity of items for which printing instructions were previously provided; and providing shipping instructions for the quantity of items that are identified for shipment not to exceed the quantity of items approved for shipment.

The method described herein may be implemented for use by consolidators by providing consolidators with password protected access to the buyer data processor to enable the consolidator to select only information associated with selected ones of the plurality of procurement orders.

The method described herein can accommodate shipments requiring a plurality of packages. For such an embodiment, the method is described as including: identifying a quantity of packages being greater than one; identifying a quantity of items identified for shipment in each of the packages; and providing printing instructions for printing a shipping label for each of the respective packages containing information related to the quantity of packages.

A system for controlling the shipment of goods from a seller to a buyer is described herein as including: a buyer data processor including a procurement database containing information related to a plurality of procurement orders placed with a plurality of sellers; a plurality of seller interface devices adapted to communicate a quantity of items identified for shipment against a selected one of the plurality of procurement orders; a communications network interconnecting the buyer data processor with the seller interface devices; logic executable by the buyer data processor for receiving the quantity of items identified for shipment and for generating instructions for printing a shipping label responsive to the quantity of items identified for shipment and further responsive to information in the procurement database related to the selected one of the plurality of procurement orders; and a printer associated with each seller interface device adapted for printing a shipping label responsive to the instructions.

The system may further comprise logic executable by the buyer data processor for generating instructions for printing a shipping label only if the quantity of items identified for shipment is less than or equal to the difference between a quantity of items ordered in the selected one of the plurality of procurement orders and a quantity of items previously identified for shipment against the selected one of the plurality of procurement orders.

The system is further described as including a bar code generator associated with the buyer data processor for generating instructions for printing a bar code on the shipping label in a predetermined format.

The system may further include a search capability associated with the buyer data processor for presenting information on a seller interface device responsive to a seller selectable criteria.

The system may further include logic executable by the buyer data processor for displaying a menu on a seller interface device for inputting information associating a plurality of packages with respective subsets of the quantity of items identified for shipment.

### BRIEF DESCRIPTION OF THE DRAWINGS

The features and advantages of the present invention will become apparent from the following detailed description of the invention when read with the accompanying drawings in which:

FIG. 1 is a schematic illustration of a computer implemented system for controlling the shipment of goods from a plurality of sellers to a buyer.

FIG. 2 is a block diagram of a portion of a process for controlling the delivery of items from a seller to a buyer.

FIG. 3 is a computer monitor display presented to a seller in one embodiment of the system of FIG. 1 for selecting information related to a particular purchase order.

FIG. 4 is a block diagram of additional portions of a process for controlling the delivery of items from a seller to a buyer.

FIG. 5 is a computer monitor display presented to a seller in one embodiment of the system of FIG. 1 for identifying the number of packages to be used for a particular shipment.

FIG. 6 is a computer monitor display presented to a seller in one embodiment of the system of FIG. 1 for printing shipping labels.

FIG. 7 is a computer monitor display presented to a seller in one embodiment of the system of FIG. 1 for viewing information regarding shipping labels that have been printed.

### DETAILED DESCRIPTION OF THE INVENTION

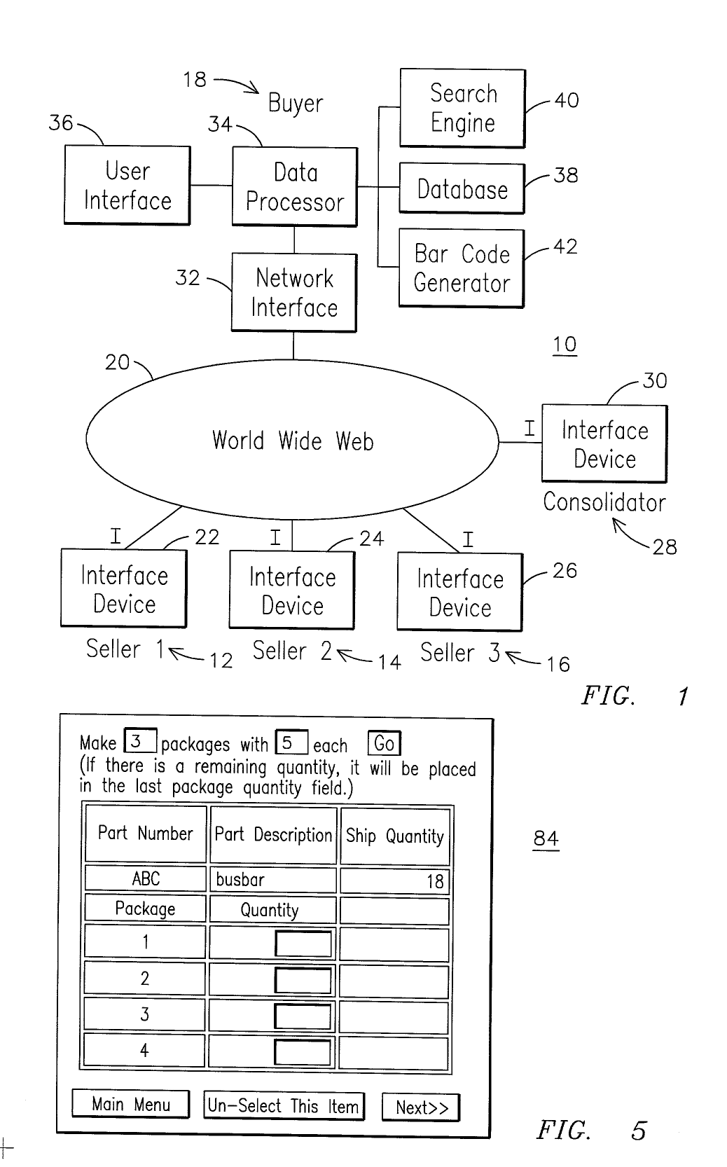

FIG. 1 is a schematic illustration of a computer implemented system 10 for controlling the shipment of goods from a plurality of sellers 12, 14, 16 to a buyer 18. System 10 utilizes the multi-media communication capabilities of the Internet World Wide Web 20 to provide communications between the various parties using the system, although one may appreciate that other communications networks may be used, such as wireless networks, private voice and data exchange networks, etc.

Each seller 12, 14, 16 gains access to the system 10 through a network interface device, 22, 24, 26. Such interface devices may be, for example, a personal computer having access to the Internet 20 and programmed with known Internet browser software. Such interface devices allow a user to transmit and to receive information in a variety of formats, such as numeric, pictorial, graphical, photographic, etc. Each interface device 22, 24, 26 includes a printing device such as a laser printer or ink jet printer as are known in the art. As will be described more fully below, such printers allow the respective sellers 12, 14, 16 to print shipping labels to be used for the shipment of items to the buyer 18. A consolidator 28 may also be connected to the system 10 through an interface device 30 via the Internet World Wide Web 20. The term consolidator is generally understood to be a person or organization that provides inventory and shipping services for a plurality of sellers. In this regard, consolidator 28 may also print shipping labels via a printing device forming part of interface device 30.

Buyer 18 accesses the system 10 through a network interface device 32 connected to a data processor 34. Data processor 34 may be, for example, a server on a corporate intranet and accessed via one or more user terminals 36. The network interface device 32 may be a connection to the Internet 20 via a corporate firewall protection device, as is known in the art. The data processor 34 may further include and/or have access to a database 38, such as magnetic or optical data storage devices as are known in the art. Data processor 34 may be programmed to execute software constituting a search engine 40 for sorting and presenting information contained in database 38 in accordance with user selectable search criteria. Data processor 34 may also include or have access to hardware and/or software constituting a bar code generator 42 for providing instructions for printing a bar code representing alpha numeric information.

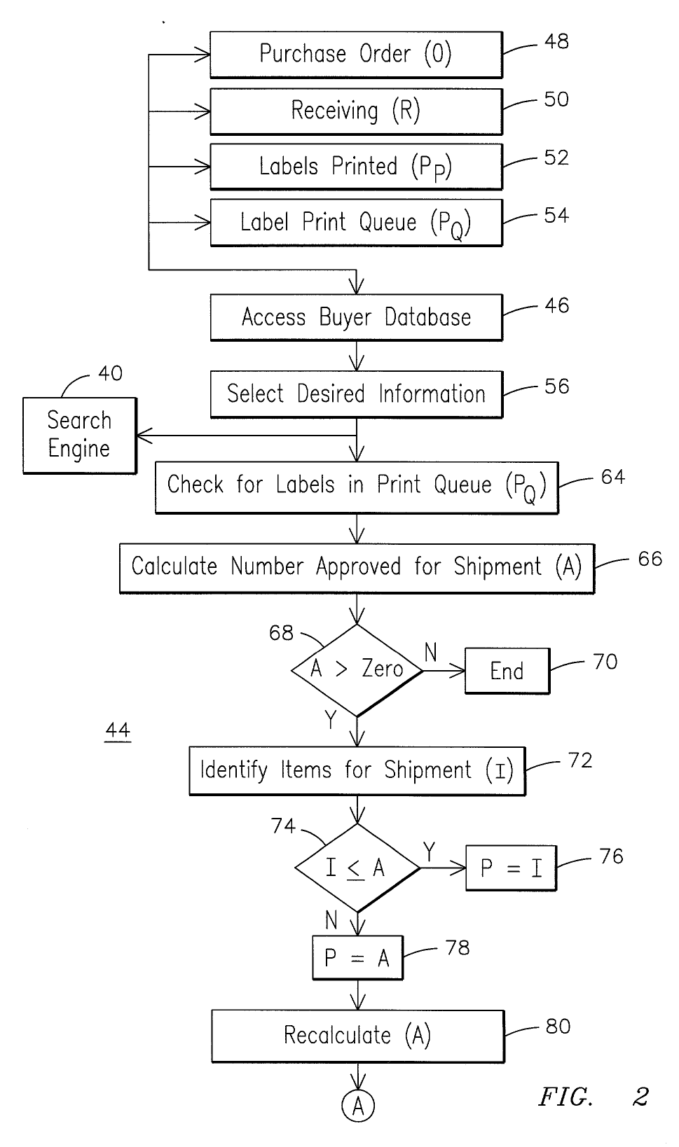

FIG. 2 illustrates a portion of a process 44 for controlling the shipment of goods from a seller to a buyer as may be practiced with the system 10 of FIG. 1. The process may begin by a seller accessing a buyer database at step 46. Conveniently, such access may be provided globally via the World Wide Web 20 or other such global communications network. Typically, such access is provided via a password protected web page wherein only those users knowing a predetermined secret password are granted access to the buyer database. Each seller 12, 14, 16 may be provided with a unique password recognizable by the buyer data processor 34 for providing access to only those portions of database 38 that are relevant to the respective seller 12, 14, 16. Consolidator 28 may be provided password protected access to procurement information contained in database 38 that is relevant to one or more sellers. Access is provided at step 46 to several types of information that may be resident on the procurement database 38. Information related to specific purchase orders may be provided at step 48. For purposes of discussion herein, a quantity of items ordered under a specific purchase order may be designated by the letter O. Information related to the quantity of items actually received by the buyer 18 may also be made available at step 50, and is referred to herein by the letter R. Historical information with regard to a quantity of labels printed P_{P} may be provided at step 52, and historical information regarding a quantity of labels prepared for printing but not yet printed P_{Q} may be provided at step 54. The derivation of P_{P} and P_{Q} will be discussed more fully below.

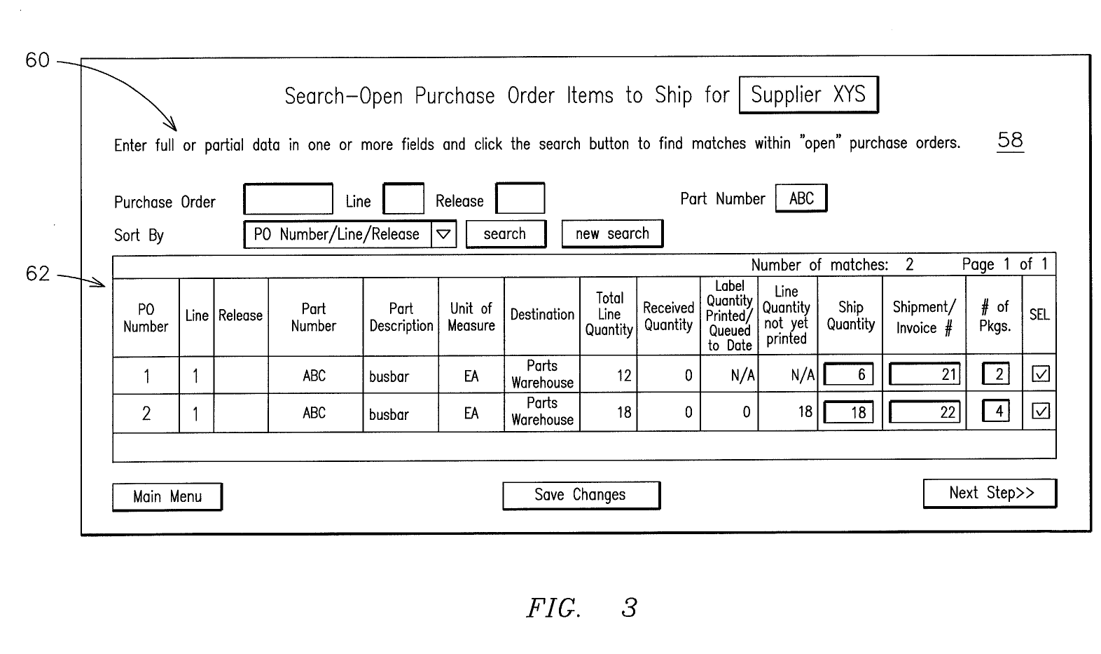

Once a seller has gained access to the buyer database at step 46, the search engine 40 may be utilized to select desired information from within the database 38 at step 56. FIG. 3 is an example of a computer monitor display that may be presented to a seller for accomplishing step 56 in one embodiment of the system 10. An upper portion 60 of display 58 provides data fields wherein a user may insert full or partial information upon which a search may be accomplished. Certain portions of the search criteria information may be presented by the use of pull-down menus as are known in the art. A bottom portion 62 of the display 58 provides the search results. The system may present complete information identified by the search, or alternatively, the system may present only summary data and allow the user to obtain additional levels of detail via known hyperlink techniques. The full multi-media power of Internet browser technology may be utilized to format the information in any desired, easy to understand format.

When a seller first connects to the buyer data processor 34 or at other times as may be desired for a particular system, the data processor 34 may be programmed to automatically check for unprinted shipping labels P_{Q} in print queue 54. The seller may be prompted for a decision regarding whether or not to print the unprinted labels at that time. This feature allows a seller who is preparing a large number of items for shipment to delay the printing of labels until all related shipping logistics have been completed. The queue 54 is durable so that any information contained therein is made available to the seller each time the seller links to the buyer data processor 34 via the communications network 20.

Data processor 34 may be programmed with logic to calculate at step 66 a quantity of items that are approved for shipment. The quantity of items approved for shipment is referred to herein by the letter A. The buyer 18 may use the quantity of items approved for shipment as a control parameter in subsequent communications with the respective seller. The number of items approved for shipment A may be calculated in any number of ways at the preference of the buyer 18. In one embodiment, the number approved for shipment may be equal to the number of items ordered minus the number of items for which shipping labels have already been prepared. This calculation may be represented by an equation.

A=O−P

In another embodiment, the number of items approved for shipment may be made equal to the number of items ordered minus the greater of the number of items actually received and the number of items for which shipping instructions have been prepared. This calculation may be represented by two alternative equations.

A=O−P(if R is less than P)

A=O−R(if R is greater than or equal to P)

For embodiments where the printing instructions may be placed into a queue prior to the actual printing of the shipping label, the number of items approved for shipment may be made equal to the number of items ordered minus the number of items for which shipping labels have been actually printed minus the number of items for which printing labels have been prepared but have not yet been printed. This calculation may be represented by an equation.

A=O−P_{P}−P_{Q}

The system 10 may automatically check to see if the number of items authorized for shipment is greater than zero at step 68. If not, the process ends at step 70 for that particular item.

Assuming that A is determined to be greater than zero, the seller may then be prompted to identify the number of items that are available for shipment at step 72. In the embodiment illustrated in FIG. 3, the seller may simply type a number into the appropriate box presented on the computer monitor display. The number of items available for shipment will be referred to by the letter I herein. System 10 then compares the number of items available for shipment I to the number of items approved for shipment A at step 74. If the number of items available for shipment is less than or equal to the number of items approved for shipment (I≦A), the system 10 will proceed to prepare shipping instructions for a quantity P equal to the number of items available for shipment I at step 76. As an additional control on the number of items to be shipped, the system will not prepare shipping instructions for any quantity of items that is greater than the current number of items approved for shipment A, as indicated in step 78. Once it is determined that shipping instructions should be prepared for a quantity P, the system 10 will then recalculate the number of items approved for shipment A at step 80 utilizing any one of the calculational techniques described above with respect to step 66.

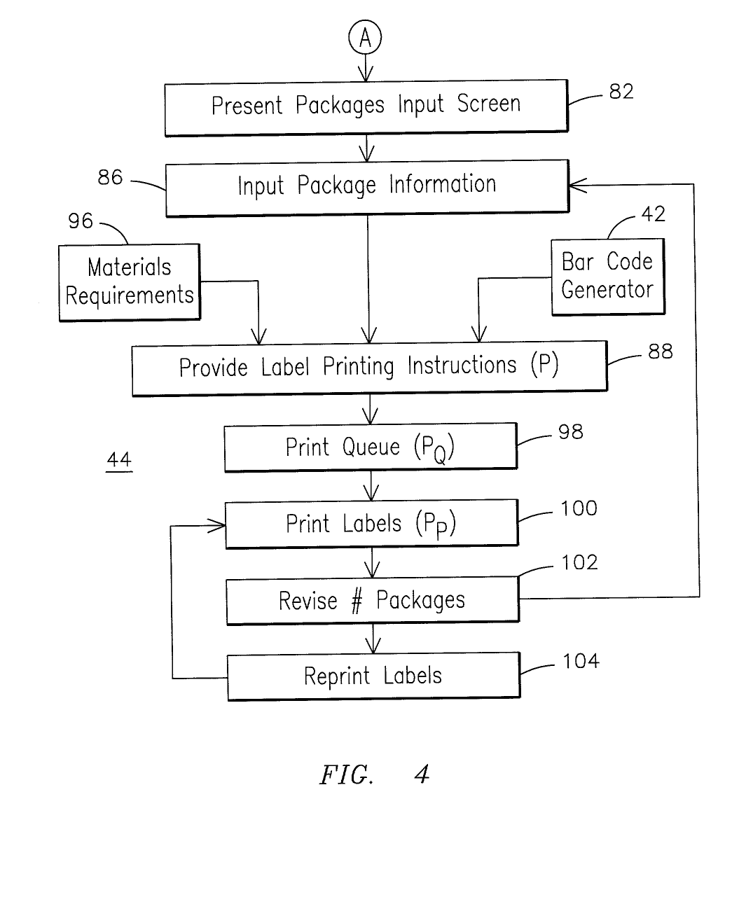

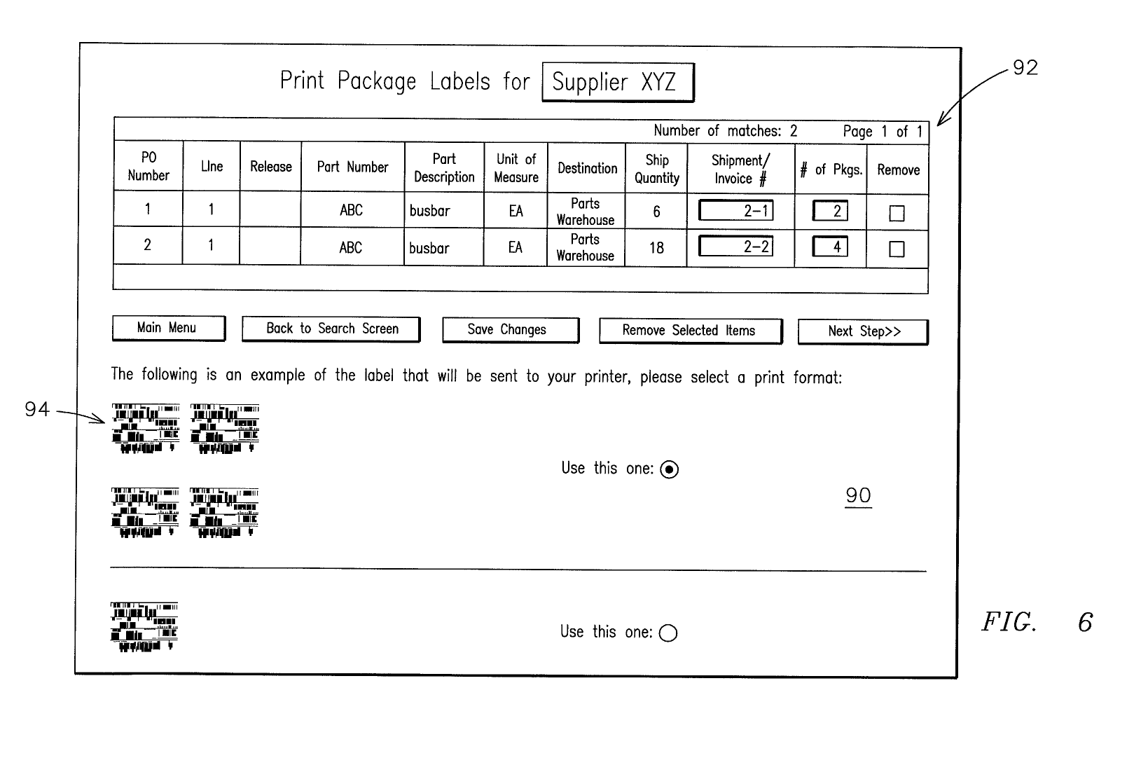

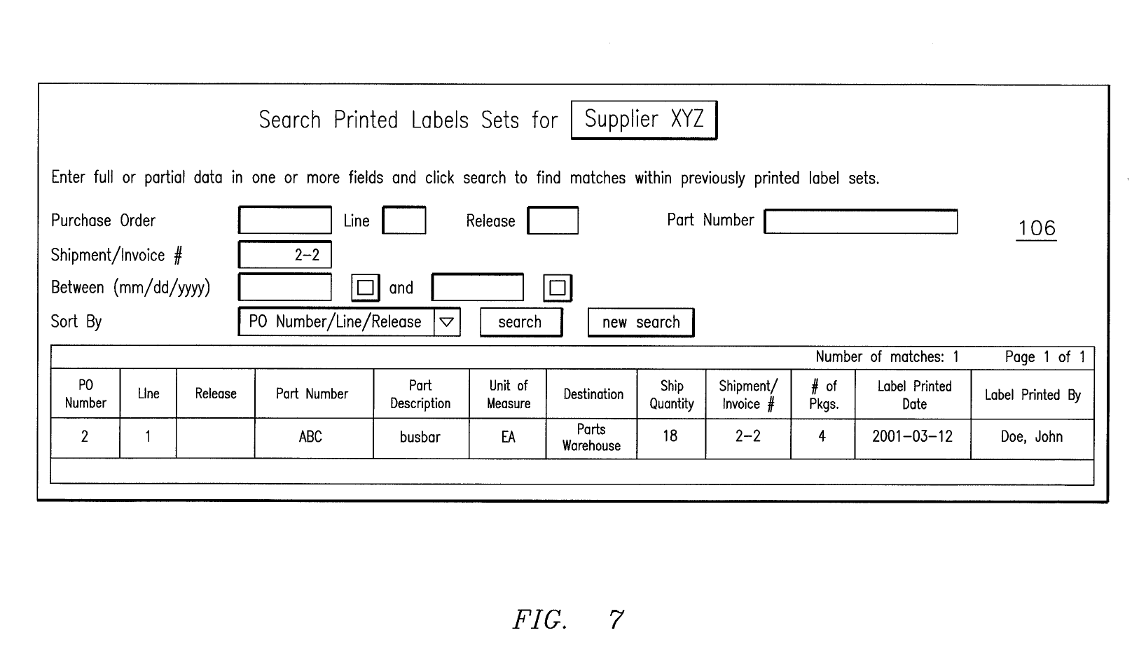

FIG. 4 illustrates additional steps in process 44 for controlling the delivery of items from a seller to a buyer. In preparing printing instructions in the form of shipping labels, system 10 may present a data input screen to the seller at step 82 to allow the seller to identify the number of packages anticipated for the shipment. FIG. 5 illustrates one embodiment of a computer monitor display 84 that may be presented to a seller at step 82 if the number of packages is greater than one. In this embodiment, system 10 provides the seller with the option of automatically dividing the quantity of items to be shipped evenly among several packages. The seller may specify any number of packages with any number of items to be contained within each package at step 86. Once the number of packages has been defined, the system 10 will provide shipping label printing instructions at step 88. The label printing instructions are communicated to the seller via the communications network 20 to be printed on a printer at the seller's location. Such printers are part of the seller interface devices 22, 24, 26, 30. FIG. 6 illustrates one embodiment of a computer monitor display 90 that may be presented to the seller for printing the shipping labels. A top portion 92 of display 90 provides the seller with a summary of the various items for which shipping labels are ready to print. The seller has the option of removing selected items prior to printing in the event that one of the shipments is not completely ready for delivery. A bottom portion 94 of display 20 allows the seller to select a print format for the labels in order to accommodate the various types of printers and paper that may be available at a particular seller's site. In this embodiment, system 10 is programmed to incorporate several bar codes as part of each shipping label. Bar code generator 42 is utilized to format the bar code in a desired style selected by the buyer 18. In this manner, system 10 allows the buyer 18 to control not only the number of items authorized for shipment, but also the style and information content to be included in the shipping labels to be used by each of the sellers 12, 14, 16.

System 10 benefits both the buyer and the sellers. The buyer 18 is better able to control the quantity of items that are shipped in order to prevent over shipments. The buyer is also provided with an advance notice of a planned shipment. Furthermore, system 10 may be programmed to direct various shipments to one or more different locations depending on the particular inventory requirements for any particular item. Such requirement may be maintained in an inventory control database accessible by data processor 34 at step 96. This may be an important control device for a “Just-In-Time” inventory control system. The sellers benefit from such a system by the added assurance that their shipments will be properly received at the buyer's location and, accordingly, that their associated invoices will be paid in a timely manner. The sellers also avoid the need to maintain a bar code generator system at the seller's location, since access to such a bar code generator 42 is provided via the buyer's web site on the World Wide Web 20. Once shipping instructions are provided to the seller, the buyer's procurement information data base 38 may be programmed to prevent modifications to the procurement instructions for the quantity of items covered by said instructions. This would prevent the situation where the buyer makes a change, such as a change in the requested delivery date, after the item has been shipped by the seller.

The printing instructions for a quantity of items P is then transferred to a print queue maintained in the buyer procurement database 38 at step 98. The seller may elect to defer the printing of the labels or to print the labels immediately at step 100. In certain circumstances, the seller may later determine that it is necessary to utilize a number of packages for shipment that is different than the number originally identified at step 86. The system 10 allows the seller to revise the number of packages at step 102 by recalling the shipping information and revising the information provided at step 86. Similarly, the system 10 allows the seller to reprint labels at step 104 in the event that the original labels are lost, damaged or otherwise become unusable. FIG. 7 illustrates one embodiment of a computer monitor display 106 that may be used to provide the seller with information regarding shipping labels that have been printed in order to facilitate the selection of specific labels for reprinting.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

We claim as our invention:

1. A computer implemented method of controlling the shipment of goods from a seller to a buyer, the method comprising:
accessing a buyer data processor including a procurement database from a seller interface device via a communications network;
identifying via the seller interface device a quantity of items associated with a selected procurement order that are identified for shipment; and
providing shipping instructions from the buyer data processor for the quantity of items.

2. The method of claim 1, further comprising providing the shipping instructions in the form of printing instructions for enabling the seller interface device to print a shipping label in a predetermined format to be used for delivery of the items to the buyer.

3. The method of claim 2, further comprising:
maintaining in the procurement database a quantity of items approved for shipment equal to a quantity of items ordered minus a quantity of items for which printing instructions were previously provided; and
providing shipping instructions for the quantity of items that are identified for shipment not to exceed the quantity of items approved for shipment.

4. The method of claim 2, further comprising:
maintaining in the procurement database a quantity of items received associated with the selected procurement order;
maintaining in the procurement database a quantity of items approved for shipment equal to a quantity of items ordered minus the greater of a quantity of items for which printing instructions were previously provided and the quantity of items received; and
providing shipping instructions for the quantity of items that are identified for shipment not to exceed the quantity of items approved for shipment.

5. The method of claim 3, further comprising:
maintaining the printing instructions in a queue file until the shipping label is printed; and
identifying the presence of printing instructions in the queue file upon the selection of information associated with the procurement order.

6. The method of claim 2, further comprising providing the printing instructions to enable the seller interface device to print a bar code in a predetermined format on the shipping label.

7. The method of claim 1, further comprising:
maintaining in the procurement database a quantity of items approved for shipment for each of a plurality of procurement orders; and
selecting information from the procurement database for a particular procurement order only if the quantity of items approved for shipment for the particular procurement order is greater than zero.

8. The method of claim 1, further comprising:
maintaining in the procurement database a quantity of items approved for shipment for the selected procurement order;
comparing the quantity of items identified for shipment with the quantity of items approved for shipment for the selected procurement order; and
providing the shipping instructions for a quantity of items no more than the quantity of items approved for shipment for the selected procurement order.

9. The method of claim 1, further comprising:
maintaining information associated with a plurality of procurement orders with a plurality of sellers in the procurement database;
providing password protected access to the buyer data processor so that information associated with only predetermined procurement orders may be selected under a particular password; and
providing a consolidator with password protected access to the buyer data processor to enable the consolidator to select only information associated with selected ones of the plurality of procurement orders.

10. The method of claim 2, further comprising:
identifying a quantity of packages associated with the quantity of items identified for shipment; and
providing printing instructions for printing on the seller interface device a quantity of shipping labels responsive to the quantity of packages.

11. The method of claim 7, further comprising:
identifying a quantity of packages;
identifying a quantity of items identified for shipment in each of the packages; and
providing printing instructions for printing a shipping label for each of the respective packages containing information related to the quantity of packages.

12. The method of claim 11, further comprising displaying an input form on the seller interface device for communicating information related to the packages to the buyer data processor via the communications network.

13. The method of claim 1, further comprising:
providing a search capability in the buyer data processor for presenting information associated with a plurality of procurement orders on the seller interface device in a format responsive to a seller selected criteria; and
selecting information associated with one of a plurality of procurement orders presented on the seller interface device in response to a seller's use of the search capability.

14. The method of claim 1, further comprising:
maintaining in the procurement database an open procurement order file containing information regarding a quantity of items ordered, a labels printed file containing information regarding a quantity of items for which a shipping label has been printed in response to shipping instructions, and a queue file containing information regarding a quantity of items for which shipping instructions have been provided but no shipping label has been printed; and
providing shipping instructions in response to a quantity of items identified for shipment only if the quantity of items ordered minus the quantity of items for which a shipping label has been printed minus the quantity of items for which shipping instructions have been provided but no shipping label has been printed is greater than or equal to the quantity of items identified for shipment.

15. The method of claim 1, further comprising providing shipping instructions for delivering the items identified for shipment to a location selected in response to a delivery priority list maintained in the procurement database.

16. The method of claim 2, further comprising requesting a repeat of printing instructions for enabling the seller interface device to reprint a shipping label.

17. The method of claim 2, further comprising:
identifying a quantity of packages associated with the quantity of items identified for shipment;
providing printing instructions for printing on the seller interface device a quantity of shipping labels responsive to the quantity of packages;
identifying a revised quantity of packages; and
requesting revised printing instructions for enabling the seller interface device to print revised shipping labels responsive to the change in the quantity of packages.

18. A system for controlling the shipment of goods from a seller to a buyer, the system comprising:
a buyer data processor including a procurement database containing information related to a plurality of procurement orders placed with a plurality of sellers;
a plurality of seller interface devices adapted to communicate a quantity of items identified for shipment against a selected one of the plurality of procurement orders;
a communications network interconnecting the buyer data processor with the seller interface devices;
logic executable by the buyer data processor for receiving the quantity of items identified for shipment and for generating instructions for printing a shipping label responsive to the quantity of items identified for shipment and further responsive to information in the procurement database related to the selected one of the plurality of procurement orders; and
a printer associated with each seller interface device adapted for printing a shipping label responsive to the instructions.

19. The system of claim 18, further comprising logic executable by the buyer data processor for generating instructions for printing a shipping label only if the quantity of items identified for shipment is less than or equal to the difference between a quantity of items ordered in the selected one of the plurality of procurement orders and a quantity of items previously identified for shipment against the selected one of the plurality of procurement orders.

20. The system of claim 18, further comprising logic executable by the buyer data processor for generating instructions for printing a shipping label only if the quantity of items identified for shipment is less than or equal to the difference between a quantity of items ordered in the selected one of the plurality of procurement orders and the greater of a quantity of items previously identified for shipment against the selected one of the plurality of procurement orders and a quantity of items received for the selected one of the plurality of procurement orders.

21. The system of claim 18, further comprising a bar code generator associated with the buyer data processor for generating instructions for printing a bar code on the shipping label in a predetermined format.

22. The system of claim 18, further comprising:
a queue associated with the buyer data processor for storing the instructions for printing; and
logic executable by the buyer data processor for displaying a notification on a seller interface device responsive to instructions for printing stored in the queue.

23. The system of claim 18, further comprising a search capability associated with the buyer data processor for presenting information on a seller interface device responsive to a seller selectable criteria.

24. The system of claim 18, further comprising logic executable by the buyer data processor for displaying a menu on a seller interface device for inputting information associating a plurality of packages with respective subsets of the quantity of items identified for shipment.

25. The system of claim 24, further comprising logic executable by the buyer data processor for generating instructions for printing a plurality of shipping labels responsive to the information input via the menu.

26. The system of claim 18, further comprising:
memory associated with the procurement database for storing the instructions for printing a shipping label; and
logic executable by the buyer data processor for recalling instructions stored in the memory in response to a request for re-printing the shipping label.
